(19) United States
(12) Patent Application Publication
(10) Pub. No.: US 2003/0229738 A1
(43) Pub. Date: Dec. 11, 2003

(54) Controller interface

(75) Inventors: James Zhuge, Palo Alto, CA (US); Zhengge Tang, San Jose, CA (US)

Correspondence Address: BAKER & HOSTETLER LLP, Washington Square, Suite 1100, 1050 Connecticut Avenue, N.W., Washington, DC, 20036, US

(73) Assignee: Dactron

(21) Appl. No.: 10/431,362

(22) Filed: May 8, 2003

Related U.S. Application Data
(63) Continuation-in-part of application No. 10/161,655, filed on Jun. 5, 2002.

(51) Int. Cl. G06F 13/00

(52) U.S. Cl. 710/100

(57) ABSTRACT

An interface includes a slave digital signal processor (DSP) and a master DSP connected to the slave DSP through a communications port. The master DSP includes a memory; and a direct memory access (DMA) to the memory. A field programmable gate array (FPGA) is connected to the master DSP. The FPGA includes a dual port random access memory (RAM) in communication with the DMA. A universal serial bus (USB) interface is connected to the FPGA through the dual port RAM.

### RELATED APPLICATIONS

This application is a Continuation-in-Part (CIP) of U.S. application Ser. No. 10/161,655 filed on Jun. 5, 2002, the entire disclosure of which is hereby incorporated by reference.

### FIELD OF THE INVENTION

The present invention relates generally to data acquisition and signal processing. More particularly, the present invention relates to transmitting data between devices.

### BACKGROUND OF THE INVENTION

Technology is evolving at a rapid pace. New electronic products are being developed and marketed everyday. As more and more people use more and more products, it becomes increasingly important to have these products communicate with one another. In the past communication was achieved through the use of serial ports and parallel ports. This, in many cases, would involve the use of cables and specialized connectors to be attached to each of the products for proper communications.

In this information age, technology has been increasing steadily and the demand for more and more information has been increasing. Because of this demand, more information is required to be transferred and standard types of communications are becoming obsolete and outdated.

One of the main factors in selecting a communications protocol is speed and error rate of the transmission of data. Consumers are very aware of the time it takes to transfer data and expect zero error. Thus, speed becomes the primary factor in choosing a communications protocol.

Universal serial bus (USB) and FireWire are some of the more recent technologies that have been implemented in order to satisfy the speed download requirements of consumers. More particularly, the cutting edge technology has been in USB 2.0 and FireWire in creating a speedy data transfer rate with plug and play capability.

### SUMMARY OF THE INVENTION

In one embodiment of the invention, an apparatus for providing a communications interface includes a master processor having a memory, and a direct memory access (DMA) to the memory. Control logic is in communication with the master processor. The control logic includes a dual port random access memory (RAM) in communication with the DMA. A communications interface is in communication with the control logic through the dual port RAM. The above can be contained on a single Printed Circuit Board (PCB).

The apparatus can also include a slave processor in communication with the master processor through a communications port. The slave processor can be in direct communication with the communications interface. This can be through an I²C-Bus. The slave processor can also be in communication with the communications interface through a field programmable gate array.

The slave processor and the master processor can be digital signal processors.

The control logic can be a Field Programmable Gate Array (FPGA).

The communications interface can be a universal serial bus (USB) interface, a FireWire interface or any other type of interface.

In another embodiment of the invention, a method for transmitting data through a communications interface includes the steps of storing data in a memory of a master processor where the memory has a direct memory access (DMA); transmitting data from the memory of the master processor to a dual-port random access memory (RAM) in a control logic circuit through the DMA; and transmitting data from the dual-port RAM to a communications interface.

The method can further include the step of transmitting data from a slave processor memory to the memory of the master processor through a slave DMA.

The method can also include the step of transmitting data from a slave processor memory to the communications interface through an I²C-Bus.

The method can additionally include the step of transmitting data from a slave processor memory to the communications interface through a field programmable gate array.

In an alternate embodiment of the invention, a system for transmitting data through a communications interface includes means for storing data in a memory of a master processor, said memory having a direct memory access (DMA); means for transmitting data from the memory of the master processor to a dual-port random access memory (RAM) in a control logic circuit through the DMA; and means for transmitting data from the dual-port RAM to a communications interface.

The system can further include means for transmitting data from a slave processor memory to the memory of the master processor through a slave DMA.

The system can also include means for transmitting data from a slave processor memory to the communications interface through an I²C-Bus.

The system can additionally include means for transmitting data from a slave processor memory to the communications interface through a field programmable gate array.

In another embodiment of the invention, an interface includes a slave digital signal processor (DSP) and a master DSP connected to the slave DSP through a communications port. The master DSP includes a memory, and a direct memory access (DMA) to the memory. A field programmable gate array (FPGA) is connected to the master DSP. The FPGA includes a dual port random access memory (RAM) in communication with the DMA. A universal serial bus (USB) interface is connected to the FPGA through the dual port RAM.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a single Printed Circuit Board having two digital signal processors (DSPs).

FIG. 2 is an illustration of a Master/Slave configuration.

FIG. 3 is an illustration of a Mater/Slave hardware configuration utilizing a Universal Serial Bus (USB) interface.

FIG. 4 is an illustration of a Master Board having a USB DSP and Front End Processing (FEP) DSP.

FIG. 5 is an illustration of a Slave Board having an inactive USB DSP and a FEP DSP.

### DETAILED DESCRIPTION OF THE INVENTION

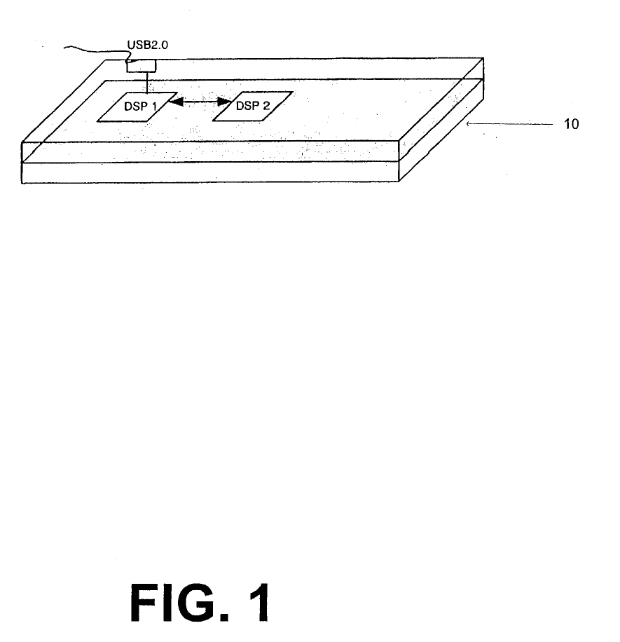

The present invention is an interface for connecting two devices together. FIG. 1 is the hardware structure of one embodiment of the invention. In this embodiment of the invention, the device has eight channels. The processors, DSP1 and DSP2, are resident on a single printed circuit board (PCB). DSP1 and DSP2 are in communication with each other.

DSP1 is attached to an interface such as a USB interface. However, it is noted that this interface is not limited to a USB interface but can be FireWire, USB 1.0, USB 2.0, etc.

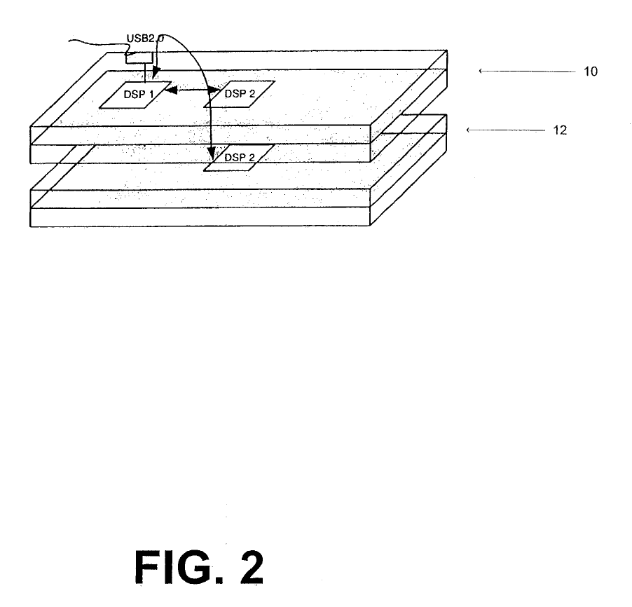

FIG. 2 is another embodiment of the invention disclosing the hardware structure of a master and slave configuration. The first PCB 10 has a first and second processor, DSP1 and DSP2. Similar to FIG. 1, DSP1 and DSP2 are connected to one another for communications. Additionally, DSP1 is connected to an interface such as a USB 2.0 interface. However as previously discussed, this is not limited to USB 2.0 and could be any communications interface such as USB 1.0, USB 2.0, FireWire, etc.

The slave PCB 12 is connected to the master PCB 10. PCB 12 includes a DSP2 and could include a DSP1 which is inactive. In this embodiment of the invention PCB 12 includes a DSP2 processor and an inactive DSP1 processor. As is shown in FIG. 2, processor DSP2 on PCB 12 is connected to DSP1 of PCB 10.

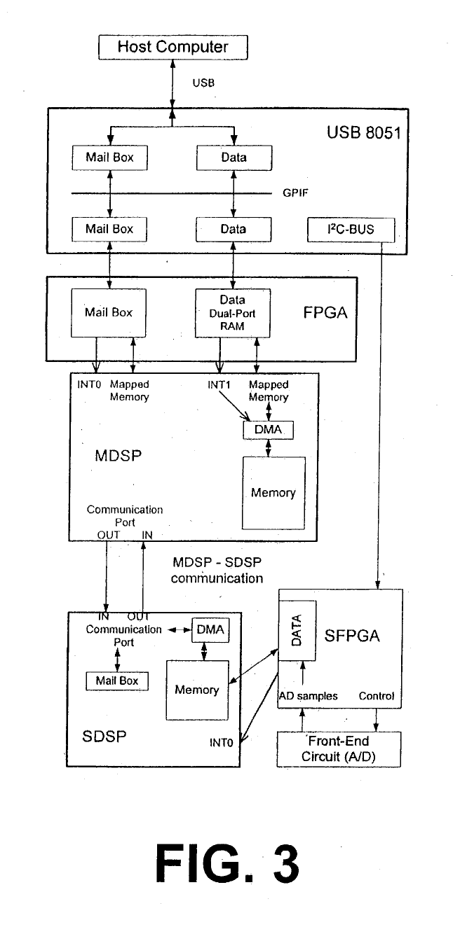

FIG. 3 is a hardware configuration of a master, slave configuration as depicted in FIG. 2. In this embodiment of the invention, a Host Computer is connected to the interface, which in this case is a USB interface. It is noted that this interface is not limited to being a USB interface but could be a USB 1.0, USB 2.0, FireWire, etc. interface.

As illustrated in FIG. 3, the Master DSP (MDSP) includes a Direct Memory Access (DMA) and a memory in communication with the DMA. Also included on this first PCB 10 is a Field Programmable Gate Array (FPGA) and a USB interface. The FPGA includes a Mail Box and a data dual-port Random Access Memory (RAM). The USB interface includes a Mail Box and a data stream on both the input and output portions of the interface. This is also done through a General-Purpose Programmable Interface (GPIF). An I²C-bus can also be implemented.

The slave processor or PCB 12 can include a slave DSP (SDSP) having a Mail Box, a DMA and a memory in communication with the DMA. The slave DSP can also include an FPGA or a slave FPGA (SFPGA). This SFPGA can include a data stream and inputs and outputs to a front end circuit A/D converter.

In this embodiment of the invention, the slave DSP (SDSP) will receive the raw data. Once received in the SDSP, the data is placed in memory. When the master DSP is ready to receive this data it will send or a signal will be sent to the SDSP indicating that the master is ready to receive this data from memory. The data will be transferred from memory in the SDSP through the SDSP DMA to the MDSP memory. Once the MDSP memory receives the data then the MDSP will indicate to the FPGA when it is ready to download the data stored in the memory in the MDSP. An interrupt can be sent to the MDSP when the host computer is ready to receive the information. This will initiate an interrupt to the MDSP DMA indicating that data is ready to be transmitted. The DMA will download this memory data from the memory without the use of the master processor thereby accelerating the speed of data transfer to the data dual port RAM located in the FPGA. The data will then be transmitted as input data through the USB 8051 and be transmitted through the GPIF to the output data port and into the host computer.

In some cases it may be beneficial to simply transmit the raw data that is received straight from the SDSP to the USB interface. In this instance the SFPGA can be utilized to download the memory directly from the SDSP to the USB through and I²C-bus. This may increase the speed of data transfer by eliminating the step of sending the data through the MDSP.

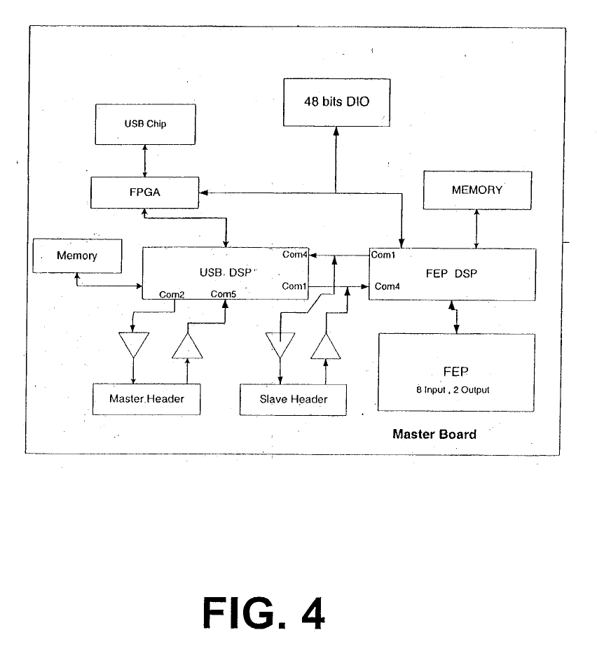

FIG. 4 is an illustration of an embodiment of the invention of a master board or master DSP of the present invention. In this embodiment of the invention there is a USB DSP and Front End Processing (FEP) DSP. The FEP has eight inputs and two outputs in this embodiment of the invention. As can be seen in this diagram the master header is communicated to the USB DSP through COMM 2 and COMM 5 and the slave header is communicated through COMM 1 and COMM 4. Each of the DSP's, the USB DSP and FEP DSP, have associated memories. The USB DSP communicates through the interface, in this case the USB interface, through an FPGA as previously discussed.

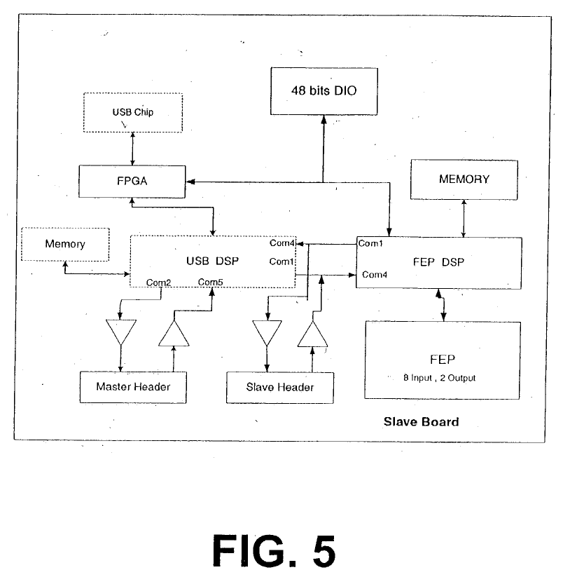

In FIG. 5 a slave board is disclose. In this case the slave board can be identical to the master board except that the USB DSP is disabled. This may benefit in cost savings since a single board can be used as the master or the slave. This can be accomplished by disabling the USB DSP when in slave mode. It is noted that optionally the FPGA can be left active so that the FEP DSP can communicate directly to the USB chip without having to communicate with the master board.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. An apparatus for providing a communications interface, the apparatus comprising:
a master processor having:
a memory, and
a direct memory access (DMA) to said memory;
control logic in communication with said master processor, said control logic comprising a dual port random access memory (RAM) in communication with said DMA; and
a communications interface in communication with said control logic through said dual port RAM.

2. The apparatus as recited in claim 1 further comprising a slave processor in communication with said master processor through a communications port.

3. The apparatus as recited in claim 2 wherein said slave processor is in communication with said communications interface.

4. The apparatus as recited in claim 3 wherein said slave processor is in communication with said communications interface through an I²C-Bus.

5. The apparatus as recited in claim 1 wherein said slave processor is in communication with said communications interface through a field programmable gate array.

6. The apparatus as recited in claim 1 wherein said apparatus is contained on a single PCB board.

7. The apparatus as recited in clam 1 wherein said slave processor is a slave digital signal processor.

8. The apparatus as recited in claim 1 wherein said master processor is a master digital signal processor.

9. The apparatus as recited in claim 1 wherein said control logic is a field programmable gate array.

10. The apparatus as recited in claim 1 wherein said communications interface is a universal serial bus (USB) interface.

11. The apparatus as recited in claim 1 wherein said communications interface is a FireWire interface.

12. A method for transmitting data through a communications interface, the method comprising the steps of:
storing data in a memory of a master processor, said memory having a direct memory access (DMA);
transmitting data from the memory of the master processor to a dual-port random access memory (RAM) in a control logic circuit through the DMA; and
transmitting data from the dual-port RAM to a communications interface.

13. The method as recited in claim 12 further comprising the step of transmitting data from a slave processor memory to the memory of the master processor through a slave DMA.

14. The method as recited in claim 12 further comprising the step of transmitting data from a slave processor memory to the communications interface through an I²C-Bus.

15. The method as recited in claim 12 further comprising the step of transmitting data from a slave processor memory to the communications interface through a field programmable gate array.

16. A system for transmitting data through a communications interface, the system comprising:
means for storing data in a memory of a master processor, said memory having a direct memory access (DMA);
means for transmitting data from the memory of the master processor to a dual-port random access memory (RAM) in a control logic circuit through the DMA; and
means for transmitting data from the dual-port RAM to a communications interface.

17. The system as recited in claim 16 further comprising means for transmitting data from a slave processor memory to the memory of the master processor through a slave DMA.

18. The system as recited in claim 16 further comprising means for transmitting data from a slave processor memory to the communications interface through an I²C-Bus.

19. The system as recited in claim 16 further comprising means for transmitting data from a slave processor memory to the communications interface through a field programmable gate array.

20. An interface comprising:
a slave digital signal processor (DSP);
a master DSP connected to said slave DSP through a communications port, said master DSP comprising:
a memory; and
a direct memory access (DMA) to said memory;
a field programmable gate array (FPGA) connected to said master DSP, said FPGA comprising a dual port random access memory (RAM) in communication with said DMA; and
a universal serial bus (USB) interface connected to said FPGA through said dual port RAM.
